(19) United States
(12) Patent Application Publication
(10) Pub. No.: US 2007/0138153 A1
(43) Pub. Date: Jun. 21, 2007

(54) Wide web laser ablation

(76) Inventor: Dean E. Redman, Austin, TX (US)

Correspondence Address: 3M INNOVATIVE PROPERTIES COMPANY, PO BOX 33427, ST. PAUL, MN, 55133-3427, US

(21) Appl. No.: 11/326,675

(22) Filed: Dec. 20, 2005

(51) Int. Cl. B23K 26/38

(52) U.S. Cl. 219/121.69

(57) ABSTRACT

Circuits on a wide web are made by a method in which a circuit and an index marker are patterned on a first row of the wide web. The wide web is then shifted to a second row. The index marker in the first row of the wide web is sensed, and a circuit in the second row is patterned in the wide web in response to sensing the index marker in the first row, thereby ensuring that circuits in the first and second rows are aligned in the cross-web direction.

### BACKGROUND

This invention relates generally to removing a coating from a substrate. More specifically, it relates to patterning of flexible circuits by removing a coating from a polymer substrate using laser ablation.

Flexible circuits are circuits that are formed on a flexible dielectric substrate, such as a polymer. The circuits may have one or more conductive layers as well as circuitry on one or both surfaces. Flexible circuits are typically useful for electronic packages where flexibility and weight control are important. In many high volume situations, flexible circuits also provide cost advantages associated with efficiency of manufacturing.

Surface layer materials of flexible circuits are often imaged or patterned. Patterned conductive surface layers may be used in passive and active electronic circuits, display components, antennas for radio frequency identification tags, and antennae for communication devices.

The surface layer of a flexible circuit may be patterned by laser ablation. Laser ablation is a process by which material is removed as a result of incident laser light. In most metals, the removal is by vaporization of the material due to heat. In polymers, the removal can be by photochemical changes which include a chemical dissolution of the polymer, akin to photolithography.

In a typically laser ablation process, a flexible circuit is coated with a thin layer of metal material, and a pattern in the metal layer is formed by penetrating the metal layer with patterned laser radiation down to the interface between the metal layer and the polymer that forms the flexible circuit. This process leads to the formation of a plasma plume, which in turn results in explosive removal of the metal layer according to the laser radiation pattern.

Excimer lasers are pulsed lasers that have a relatively low duty cycle. That is, the time of the pulse width is very short compared to the time between pulses. Therefore, even though excimer lasers have a low average power compared to other larger lasers, the peak power of the excimers can be quite large. Excimer lasers typically have a flux density that is several orders of magnitude higher than other lasers. As a result, it is possible to ablate a much larger area with an excimer laser.

Currently, in order to utilize high powered excimer lasers to pattern flexible circuits, the size of the circuit being patterned is limited by the ablation threshold of the surface materials and the power of the laser. For example, in a typical process about 1 milli-Joule of laser energy can ablate about 1 nano-meter (nm) of gold in an area of about 1 square centimeter. Wide web flexible circuit manufacturing requires that many small circuits be aligned in a repeating pattern on a continuous web that is typically on the order of 12 to 14 inches wide and 500 feet long. Currently, to pattern circuits on a wide web, the web is held static while an area of the web containing a small number of circuits is located in the region of exposure to the excimer laser beam. Then, either the laser or the wide web must be moved in the down-web direction and the process repeated. As a result, the process of patterning circuits on the wide web is very slow.

Typically, the wide web is rolled on a roller, and a row of circuits (in the down-web direction) is patterned as described above. The web or the laser is then moved in the cross-web direction, and the process is repeated to ablate another row of circuits. This procedure is repeated until the web is filled with rows of ablated circuits. The web is then subjected to further processing steps such as applying a patterned covercoat or cutting the circuits apart to form a large number of individual patterned circuits. Because subsequent processing steps are often simultaneously carried out on more than one circuit in the cross-web direction, it is desirable that the circuits be aligned in the cross-web direction so that the subsequent processing steps can be accurately performed for each circuit.

Therefore, there is a need for a way to rapidly pattern rows of circuits on a wide web substrate so that adjacent circuits in the cross-web direction are aligned with one another without sacrificing the quality of the circuits being patterned.

### SUMMARY

An aspect of the invention is a method for patterning wide web circuits in which a series of index markers trigger the firing of a laser. The beam of the laser ablates a surface coating of the wide web to pattern an electronic circuit. Circuits are therefore formed in a manner such that adjacent circuits in the cross-web direction are aligned with one another.

### DESCRIPTION OF THE DRAWINGS

FIG. 1 is a diagram showing components that are used to perform the process of patterning wide web circuits using laser ablation according to an embodiment of the invention.

FIG. 2 is a diagram showing a portion of the first row of circuits made using the process of the invention.

FIG. 3 is a diagram showing a portion of the first and second rows of circuits made using the process of the invention.

FIG. 4 is a flow diagram illustrating the process of patterning wide web circuits using laser ablation according to an embodiment of the invention.

FIG. 5 is a cross-sectional view of a portion of a wide web showing the substrate and coating.

### DETAILED DESCRIPTION

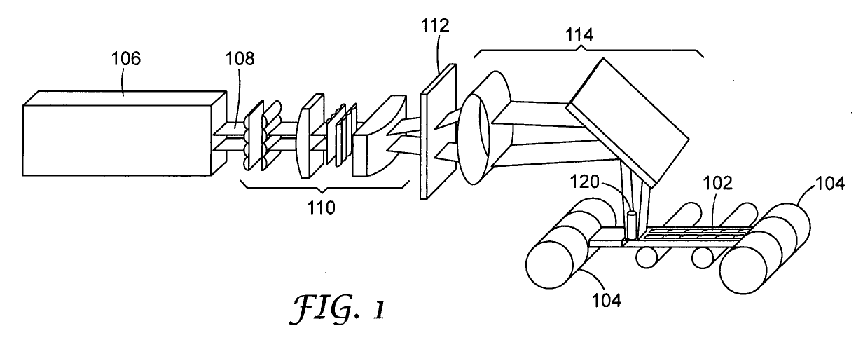

FIG. 1 shows the structure of an apparatus that is used for performing the method of the present invention. Wide web 102 is placed on rollers 104. Wide web 102 is a flexible substrate, such as a polymer, which has a coating, such as a metal, on at least one side of the substrate. Wide web 102 is thin enough that it can be easily rolled onto rollers 104. Rollers 104 roll and unroll wide web 102 so that different areas of the surface of wide web 102 are exposed.

Excimer laser 106 produces laser beam 108. Homogenizing optics 110 process laser beam 108 to produce a beam with a flat intensity profile to properly fill mask 112. Mask 112 contains a negative image of the pattern of the circuit that is to be made by the process. Mask 112 reflects some of laser beam 108 and transmits some of laser beam 108 to imaging optics 114. Imaging optics 114 adjust the shape, size and focus of the transmitted portion of laser beam 108, which is directed toward wide web substrate 102.

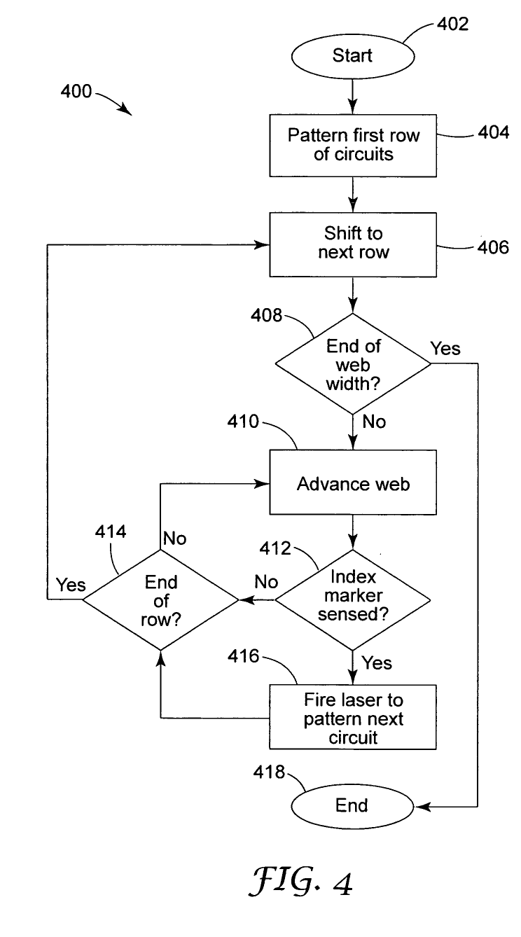

Wide web 102 is positioned so that a portion of wide web 102 is exposed to the portion of laser beam 108 that is directed toward wide web 102 by imaging optics 114. Rollers 104 roll and unroll wide web substrate 102 so that different portions of wide web 102 are exposed to the patterned laser flux that is directed toward wide web substrate 102 through imaging optics 114. When wide web 102 is exposed to electromagnetic energy such as the laser flux that is directed toward wide web substrate 102 through imaging optics 114, the laser flux ablates the coating of wide web 102. Thus, the circuit pattern that is contained in mask 108 is produced in wide web 102. Sensor 120 senses index markers on wide web 102 and triggers firing of excimer laser 106, which is discussed in more detail with respect to FIG. 4.

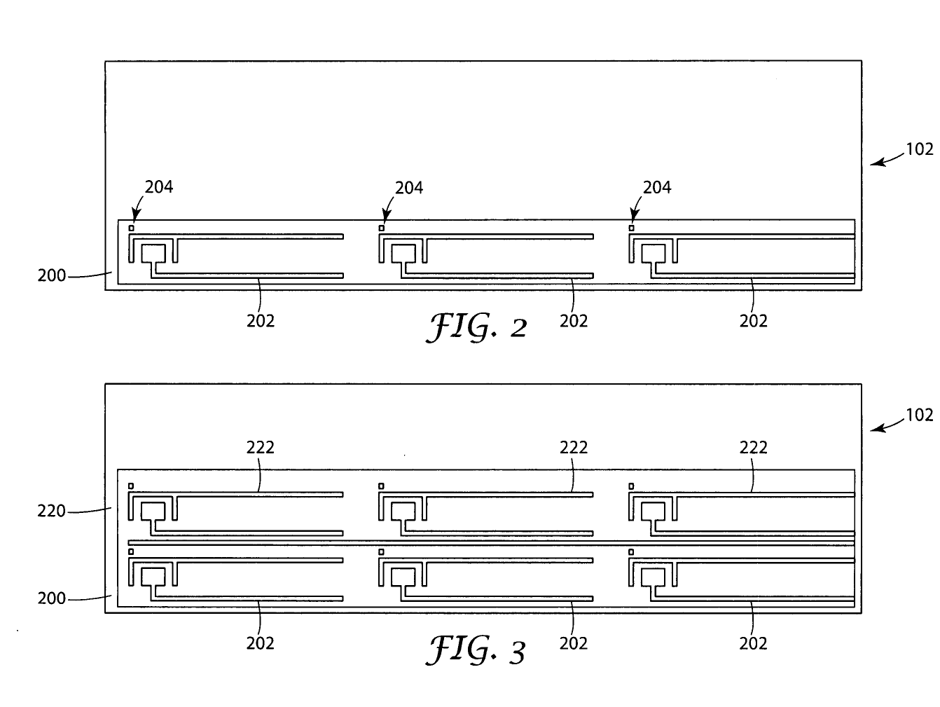

FIG. 2 shows a portion of wide web 102 after it has been patterned. A first row of circuits 200 is patterned in wide web 102 at the laser's maximum repetition rate. Each of circuits 202 contains index marker 204. Index marker 204 is a small shape, such as a rectangle, that is formed by ablating the surface coating from the substrate of wide web 102. Typically, a pattern for index marker 204 is contained in mask 112 and index marker 204 is formed in the same process in which circuit 202 is patterned in wide web 102. Index marker 204 can be any shape that fits within the circuit design, such as a line, a rectangle, a circle, an oval, an ellipse, or a square.

FIG. 3 shows wide web 102 after two rows of circuits have been patterned. Row 200 is identical to that shown in FIG. 2. Row 220 is patterned in wide web 102 by sensing index markers 204 in order to fire excimer laser 106. During the second pass of wide web 102, sensor 120 (shown in FIG. 1) senses the index markers in row 200 and excimer laser 106 is fired in response to sensing the index markers to pattern circuits 222. Sensor 120 may, for example, sense the difference in reflectivity between index marker 204, which is the exposed substrate of wide web 102, and the area around index marker 204, which is the surface coating of wide web 102. When sensor 120 senses index marker 204, it signals excimer laser 106 to fire. In this manner, a second row of circuits is patterned in wide web 102 and the circuits in the second row are aligned in the cross-web direction with the circuits in the first row. This process is repeated until the entire width of wide web 102 is filled with circuits.

FIG. 4 shows a flow chart for a process 400 of patterning circuits on a wide web using laser ablation. The process illustrated in FIG. 4 begins at start box 402. Step 404 patterns a first row of circuits 200 in wide web 102 using laser ablation. Each of the patterned circuits includes an index marker 204. After the first row of circuits is patterned, step 406 shifts the process to the next row by moving wide web 102 relative to excimer laser 106. Step 406 can be performed by either moving wide web 102 or by moving excimer laser 106. Decision step 408 determines whether the end of the width of wide web 102 in the cross-web direction has been reached. If so, process 400 ends at end box 418.

If the end of the cross-web width of wide web 102 has not been reached, step 410 advances wide web 102 in the down-web direction to pattern another circuit. In one embodiment, wide web 102 is advanced continuously by rolling wide web 102 on rollers 104. In an alternative embodiment, wide web 102 is advanced in a step-wise manner. Next, decision step 412 determines whether index marker 204 is sensed. If no index marker is sensed, decision step 414 determines whether the end of a row has been reached. If the end of the row has been reached, the process returns to step 406 to shift the process in the cross-web direction to pattern the next row in wide web 102. If the end of the row has not been reached, the process returns to step 410 and continues to advance wide web 102. If index marker 204 is sensed in decision step 412, then excimer laser 106 is fired to pattern a circuit in step 416.

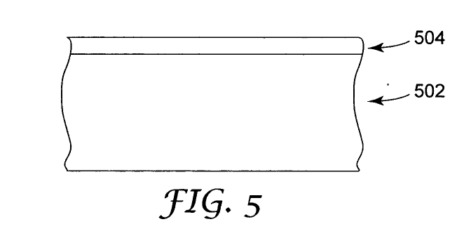

FIG. 5 shows a cross-section of wide web 102 includes substrate 502 and coating 504. Substrate 502 is any flexible backing material that is sufficiently thin that it can be rolled. Typical materials that might be used for substrate 502 are 0.002 inch thick polymide or 0.005 inch thick polyester. Coating 504 is any material that can be made to adhere to substrate 502 and subsequently ablated from substrate 502 by an excimer laser, such as copper, gold or aluminum. The thickness of coating 504 is determined by the laser ablation threshold of the material used for coating 504, the size of the circuit being patterned and the available power for the laser. A typical example of coating 504 is 50 nanometers (nm) of gold. A typical upper bound for the thickness of coating 504 for a laser with 1000 millijoules (mJ) of power is about 250 nm.

The present invention discloses a method for quickly and efficiently patterning circuits on a flexible wide web. The invention uses index markers to trigger the firing of an excimer laser, which ablates portions of the surface coating of the wide web to pattern circuits. The circuits are patterned in a number of parallel rows on the flexible wide web, and the index markers ensure that the individual circuits are aligned in the cross-web direction so that they can be easily separated for use.

Although the present invention has been described with reference to preferred embodiments, workers skilled in the art will recognize that changes may be made in form and detail without departing from the spirit and scope of the invention. For example, it is possible to make a circuit larger than the ablation area of the laser by patterning adjacent sections of a circuit in adjacent rows. In such a method, it is clearly important that the circuit sections align in the cross-web direction. Also, in such a method, the patterning mask will have to be exchanged at the end of each row if adjacent sections of the circuit are not identical.

1. A method for making wide web circuits comprising:
patterning a first circuit and an index marker on a first row of a wide web;
shifting the wide web to a second row of the wide web;
sensing the index marker in the first row of the wide web; and
patterning a second circuit in the second row in alignment with the first circuit in the first row in response to the sensing of the index marker in the first row.

2. The method of claim 1 wherein the wide web comprises a substrate with a coating.

3. The method of claim 2 wherein the coating is removable by exposure to electromagnetic energy.

4. The method of claim 3 wherein the first and second circuits are patterned by exposing the wide web to electromagnetic energy sufficient to selectively remove the coating from the substrate.

5. The method of claim 2 wherein the substrate is a polymer.

6. The method of claim 2 wherein the coating is a metal.

7. A method for making wide web circuits comprising:
providing a wide web, the wide web having a length in a down-web direction and a width in a cross-web direction;
advancing the wide web in the down-web direction;
patterning a first row of circuits and a first row of index markers on the wide web in the down-web direction as it advances;
shifting the wide web in the cross-web direction;
advancing the wide web in the down-web direction;
sensing the index markers in the first row; and
patterning a second row of circuits in the down-web direction in cross-web alignment with the first row of circuits in response to the sensing of the index markers in the first row.

8. The method of claim 7 wherein the wide web comprises a substrate with a coating.

9. The method of claim 8 wherein the coating is removable by exposure to electromagnetic energy.

10. The method of claim 9 wherein the circuits are patterned by exposing the wide web to electromagnetic energy sufficient to selectively remove the coating from the substrate.

11. The method of claim 8 wherein the substrate is a polymer.

12. The method of claim 8 wherein the coating is a metal.

13. A method for making wide web circuits comprising:
positioning a shadow mask between a wide web substrate and a source of electromagnetic energy, the shadow mask having a pattern for at least one circuit and at least one index marker and the substrate having a coating that is removable by exposure to electromagnetic energy;
exposing a first area of the coating through the shadow mask to a first flux of electromagnetic energy sufficient to pattern at least one circuit and at least one index marker on a first area of the wide web substrate by selectively removing the coating from the first area of the wide web substrate;
moving the wide web substrate relative to the source of electromagnetic energy;
sensing the index marker on the first area of the substrate; and
exposing a second area of the coating through the shadow mask to a second flux of electromagnetic energy sufficient to pattern at least one circuit and at least one index marker on a second area of the wide web substrate by selectively removing the coating from the second portion of the wide web substrate;
wherein the first and second areas are aligned by the sensing of the index mark.

14. The method of claim 13 wherein the electromagnetic energy is a laser beam.

15. The method of claim 14 wherein the laser is an excimer laser.

16. The method of claim 13 wherein the coating is removed by ablation.

17. The method of claim 13 wherein the substrate is moved and the source of electromagnetic energy is held in place.

18. The method of claim 13 wherein the substrate is a polymer.

19. The method of claim 13 wherein the coating is a metal.
